(19) United States
(12) Patent Application Publication
(10) Pub. No.: US 2022/0389653 A1
(43) Pub. Date: Dec. 8, 2022

(54) SYNTHETIC FIBER ROPES WITH LOW-CREEP HMPE FIBERS

(71) Applicant: Cortland Company, Inc., Stafford, TX (US)

(72) Inventors: Thanasis Varnava, Houston, TX (US); Wesley Conger, Houston, TX (US)

(21) Appl. No.: 17/775,758

(22) PCT Filed: Nov. 12, 2020
(86) PCT No.: PCT/US2020/060148

§ 371 Date: May 10, 2022

Related U.S. Application Data
(60) Provisional application No. 62/934,053, filed on Nov. 12, 2019.

(51) Int. Cl. D07B 1/02; D04C 1/12; D07B 5/00

(52) U.S. Cl. CPC D07B 1/025; D04C 1/12; D07B 5/006; D07B 2201/1096; D07B 2201/1014; D07B 2201/1028; D07B 2201/2009; D07B 2201/2036; D07B 2205/205; D07B 2205/2014; D07B 2205/2042; D07B 2205/2096; D07B 2501/2015; D07B 2205/2064; D10B 2331/042; D10B 2321/0211

(57) ABSTRACT

A braided rope includes a plurality of braided strands comprising twisted yarns. Each of the twisted yarns includes a blend of first fibers and second fibers. The first fibers are high modulus polyethylene (HMPE) fibers and the second fibers may be lyotropic polymer filaments, thermotropic polymer filaments, or polyphenylene benzobisoxazole fibers. The first fibers can have a creep rate of no more than 3.0×10⁻⁸ percent per second at 20° C. while subjected to a stress of 5.0 grams/dtex. The first fibers can have a creep rate of no more than 1.0×10⁻⁷ percent per second at 20° C. while subjected to a stress of 7.5 grams/dtex.

### CROSS-REFERENCE TO RELATED APPLICATIONS

The present application is related to and claims the priority benefit of U.S. Provisional Patent Application No. 62/934,053, filed Nov. 12, 2019, the entire contents of which are incorporated herein by reference.

### TECHNICAL FIELD

The present disclosure generally relates to synthetic fiber ropes. More particularly, systems and methods disclosed and contemplated herein relate to synthetic fiber ropes including multiple fiber types, where one fiber type is low-creep high modulus polyethylene (HMPE) fiber.

### INTRODUCTION

Typically, synthetic rope is made of thousands of individual synthetic filaments. Synthetic ropes have applications in a variety of industries and are subjected to differing environmental stresses and conditions. One example application involves winch and crane implementations.

When lowering heavy equipment subsea, a vessel is usually outfitted with some kind of winch and/or crane which is usually outfitted with a wire rope. The crane should have a capacity large enough to carry the weight of the equipment that is being lowered plus the weight of the wire. The higher the water depth the more the wire weighs and therefore a larger capacity crane is needed. Some offshore winch/crane systems are outfitted with an Active Heave Compensation (AHC) system. The AHC system cancels out the motion (heave) of the vessel by moving the sheaves of the traction winch system, or the drum of the direct drive winch system, back and forth, paying in and out as the vessel moves. Because the cycling is happening on a short piece of the entire rope, heat is generated at that rope location.

Heave compensation is usually turned on when going through the splashzone and during landing of the equipment right before it hits the seabed. In areas where the waterdepth is pretty constant, this creates a zone on the rope where the fatigue accumulation is pretty high while most of the rope that is not in the areas that see AHC is in good condition. Unfortunately with wire rope it is not possible to replace only sections of the rope therefore the entire rope needs to be changed.

### SUMMARY

The instant disclosure is directed to synthetic fiber ropes with multiple different fibers, where one fiber type is low-creep HMPE fiber. In one aspect, a braided rope is disclosed. The exemplary braided rope can include a plurality of braided strands comprising twisted yarns. Each of the twisted yarns includes a blend of first fibers and second fibers, where the first fibers are high modulus polyethylene (HMPE) fibers and the second fibers may be lyotropic polymer filaments, thermotropic polymer filaments, or polyphenylene benzobisoxazole fibers. The first fibers can have a creep rate of no more than 3.0×10⁻⁸ percent per second at 20° C. while subjected to a stress of 5.0 grams/dtex.

In another aspect, a method of making a braided rope is disclosed. The example method may comprise forming a plurality of rope strands, which may comprise blending together first fibers and second fibers, and braiding the plurality of rope strands together to form the braided rope. The first fibers can be high modulus polyethylene (HMPE) fibers, and the second fibers can be lyotropic polymer filaments, thermotropic polymer filaments, or polyphenylene benzobisoxazole fibers. The first fibers can have a creep rate of no more than 3.0×10⁻⁸ percent per second at 20° C. while subjected to a stress of 5.0 grams/dtex. The first fibers can have a creep rate of no more than 1.0×10⁻⁷ percent per second at 20° C. while subjected to a stress of 7.5 grams/dtex.

In another aspect, a braided rope is disclosed. The example braided rope may comprise a plurality of braided strands comprising twisted yarns. Each of the twisted yarns includes a blend of first fibers and second fibers, where the first fibers are high modulus polyethylene (HMPE) fibers and the second fibers may be lyotropic polymer filaments, thermotropic polymer filaments, or polyphenylene benzobisoxazole fibers. The first fibers can have a creep rate of no more than 3.0×10⁻⁸ percent per second at 20° C. while subjected to a stress of 5.0 grams/dtex. The first fibers can have a creep rate of no more than 1.0×10⁻⁷ percent per second at 20° C. while subjected to a stress of 7.5 grams/dtex. The second fibers may have a tensile strength of about 3200 MPa, an elongation at break of 3.3% to 3.7%, a tensile modulus of about 75.0 GPa, and a tenacity of 2.03 N/tex to 2.38 N/tex. Each of the twisted yarns may have a ratio of first fibers to second fibers of from 45:55 to 55:45 by volume. A ratio of first fibers to second fibers may be from 38:62 to 46:54 by weight.

There is no specific requirement that a material, technique or method relating to synthetic fiber ropes include all of the details characterized herein in order to obtain some benefit according to the present disclosure. Thus, the specific examples characterized herein are meant to be exemplary applications of the techniques described, and alternatives are possible.

Other independent aspects of the disclosure may become apparent by consideration of the detailed description and accompanying drawings.

### BRIEF DESCRIPTION OF THE DRAWINGS

FIG. 1 shows an exploded view of an embodiment of a rope made according to the present disclosure.

FIG. 2 shows creep rate data for DYNEEMA® SK75 at different temperatures and while subjected to different loadings.

FIG. 3 shows creep rate data for DYNEEMA® SK78 at different temperatures and while subjected to different loadings.

FIG. 4 shows percent elongation over time for four different fibers at 30° C. and a 400 MPa load: Spectra 900, Spectra 1000, DYNEEMA® SK75 and DYNEEMA® SK78.

FIG. 5 shows experimental data for 1-inch ropes having different HMPE fibers and the number of cycles to failure while subjected to dry and wet conditions.

### DETAILED DESCRIPTION

Systems and methods disclosed and contemplated herein relate to synthetic fiber ropes. Generally, the synthetic fibers in the ropes are of a first fiber type and a second fiber type. The first fiber type is a low creep, high modulus polyethylene (HMPE) fiber and the second fiber type may be a liquid crystal polymer (LCP) fiber type.

Synthetic fiber ropes disclosed and contemplated herein can be designed to have improved dynamic flex fatigue characteristics. One method for testing such characteristics is cyclical bend over sheave (CBOS) testing. During CBOS testing, a rope is cycled continuously over a rolling sheave under tension until the rope breaks. CBOS failure modes can be generally be split into 3 different failure modes: (i) creep to rupture failure, (ii) internal and external abrasion, and (iii) thermal strength loss. Creep to rupture failure is where the fibers in the rope permanently elongate until they eventually rupture (as explained below, creep is a function of time while subjected to load, amount of load and temperature). External abrasion is caused by relative motion between the rope and sheave, and internal abrasion is caused by relative motion between the fibers internally in the structure of the rope. Thermal strength loss occurs when the relative motion inside the rope generates heat during CBOS. Compared to the initial rope strength, typically measured at room temperature, the strength of the rope decreases because of the increase in rope temperature.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifier “about” used in connection with a quantity is inclusive of the stated value and has the meaning dictated by the context (for example, it includes at least the degree of error associated with the measurement of the particular quantity, manufacturing tolerances, etc.). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As is conventionally known, “creep” is the long-term, longitudinal deformation of a material over time when subjected to a continuing load. The creep tendency of an elongate body, such as a fiber, yarn or braided body may be determined, for example, by subjecting a sample to a selected sustained load (e.g. 10% of the breaking strength of the test specimen) over a selected time (e.g. 300 minutes for short term creep, or 10,000 minutes for long term creep) at a selected temperature (e.g. room temperature, such as 25° C., or heated to 70° C.) whereby the elongation of the sample is measured after the selected time expires. In this method, the creep percentage may be determined by following the creep test provided in “Predicting the Creep Lifetime of HMPE Mooring Rope Applications” by Vlasbom and Bosman, OCEANS 2006 (Conference, September 1, 2006).

### II. Exemplary Ropes

Exemplary ropes disclosed and contemplated herein can have various constructions and sizes. Certain aspects of exemplary ropes are discussed in the section below.

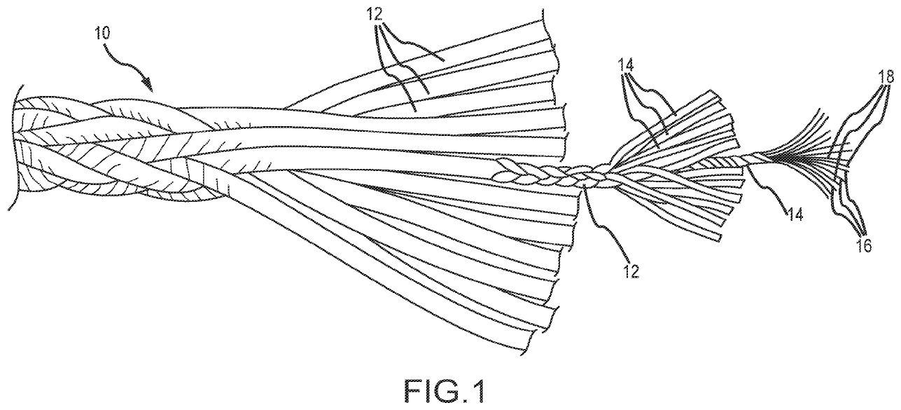

FIG. 1 shows an example rope 10. The rope 10 may be a braided rope, a wire-lay rope, or a parallel strand rope. Braided ropes are formed by braiding or plaiting the ropes together as opposed to twisting them together. Braided ropes are inherently torque-balanced because an equal number of strands are oriented to the right and to the left.

Wire-lay ropes are made in a similar manner as wire ropes, where each layer of twisted strands is generally wound (laid) in the same direction about the center axis. Wire-lay ropes can be torque-balanced only when the torque generated by left-laid layers is in balance with the torque from right-laid layers.

Parallel strand ropes are an assemblage of smaller sub-ropes held together by a braided or extruded jacket. The torque characteristic of parallel strand ropes is dependent upon the sum of the torque characteristics of the individual sub-ropes.

In FIG. 1, the rope 10 consists of a plurality of braided strands 12. The braided strands 12 are made by braiding together twisted yarns 14. In some implementations, the strands 12 have no jackets. The twisted yarns 14 comprise a first fiber bundle 16 and a second fiber bundle 18. Further information on the structure of these ropes may be found in U.S. Pat. Nos. 5,901,632, 5,931,076, and 6,945,153, the entire contents of which are hereby incorporated by reference.

Exemplary ropes can have a ratio of first fibers to second fibers, by volume, of from 45:55 to 55:45. For instance, exemplary ropes can have a ratio of first fibers to second fibers of, by volume, 45:55; 46:54; 47:53; 48:52; 49:51; 50:50; 51:49; 52:48; 53:47; 54:46; or 55:45.

Exemplary ropes can have a ratio of first fibers to second fibers, by weight, of from 38:62 to 46:54. For instance, exemplary ropes can have a ratio of first fibers to second fibers of 38:62; 39:61; 40:60; 41:59; 42:58; 43:57; 44:56; 45:55; or 46:54.

In some instances, the second fibers can have a spin-finish pre-applied before rope construction. As an example, using commercially available fiber and spin finish, a Vectran fiber is pre-applied with T147 spin finish from Kuraray (Tokyo, Japan).

In some instances, exemplary ropes have a coating that may be applied after the rope is formed and tensioned. Example coatings include polyurethane-based coatings. Typically, example coatings are high coefficient of friction coatings. An example of a commercially available coating is the Lago45 coating produced by I-Coats (Antwerp, Belgium).

Without being bound by a particular theory, it is theorized that adding a polyurethane-based, high coefficient of friction coating can improve rope life. One possible explanation is that because the coating is relatively sticky, movement between fibers is minimized and thus the rope can have longer lifetime than a slippery, abrasion resistant coating. Additionally, adding a high coefficient of friction coating can provide additional grip when the rope is used on traction winches, which can result in the winch system requiring fewer sheaves and a more compact design.

Exemplary ropes can have various strand arrangements. For instance, exemplary ropes can be 12×12 strand braided ropes, 12 strand braided ropes, 8 strand braided ropes, 3 strand braided ropes, 12×3 strand braided ropes, and double twisted ropes.

Exemplary ropes can have different sizes, which can be selected based on intended uses of the ropes as well as strand arrangements. As examples, for 12×12 strand braided rope implementations, a rope diameter can be from about 1.5 inches to about 7.5 inches; from 1.5 inches to 4 inches; from 4 inches to 7.5 inches; from 1⅝ inches to 3¼ inches; from 2 inches to 5 inches; or from 3¼ inches to 7.5 inches.

As examples, for 12 strand braided rope implementations, a rope diameter can be from about ¾ inch to about 2 inches; from 1 inch to 1¾ inches; from ¾ inch to 1.5 inches; or from 1 inch to 2 inches.

Typically, the first fibers and the second fibers are blended inside the strands. Without being bound by a particular theory, it appears that blending the first fibers and second fibers, in contrast to using the first fibers as an overlay/veneer around the second fibers, improves the rope life as tested by CBOS testing. In some implementations, the first fibers and the second fibers are evenly blended inside the strands.

Exemplary ropes can be used in various industries and for various applications. For instance, exemplary ropes can be used in deep sea applications, in lifting applications, as towing or tug lines, and mooring and docking lines, to name a few examples.

### III. Exemplary Rope Fibers

As mentioned above, example ropes described and contemplated herein include first fibers and second fibers. Various aspects of exemplary first fibers and second fibers are discussed below.

The first fibers are low creep, high modulus polyethylene (HMPE) fibers. HMPE fibers may be spun from ultrahigh molecular weight polyethylene (UHMWPE) resin. Exemplary first fibers have a low creep rate. For instance, example first fibers can have a creep rate of no more than 3.0×10⁻⁸ percent per second at 20° C. while subjected to a stress of 5.0 grams/dtex. The first fibers can have a creep rate of no more than 1.0×10⁻⁷ percent per second at 20° C. while subjected to a stress of 7.5 grams/dtex. The first fibers can have a creep rate of no more than 2.0×10⁻⁷ percent per second at 20° C. while subjected to a stress of 8.75 grams/dtex. The first fibers can have a creep rate of no more than 1.0×10⁻⁶ percent per second at 20° C. while subjected to a stress of 12.25 grams/dtex. The first fibers can have a creep rate of no more than 2.0×10⁻⁶ percent per second at 20° C. while subjected to a stress of 15 grams/dtex.

Commercially available examples of low-creep HMPE fibers include DYNEEMA® SK75, Dyneema® DM20, and DYNEEMA® SK78 from DSM NV of Heerlen, The Netherlands, Teximus AR from Winyarn of Beijing, China, and JF-33 by Jonnyma of Jiansgu Province, China. Teximus AR is published as having a creep rate of 2.62×10⁻⁶ percent per second at 25° C. while subjected to a stress of 6.25 grams/dtex.

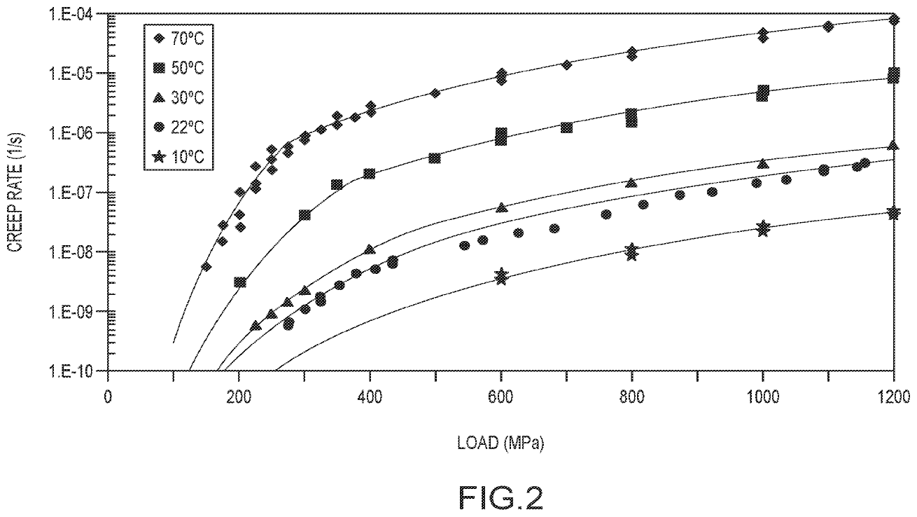

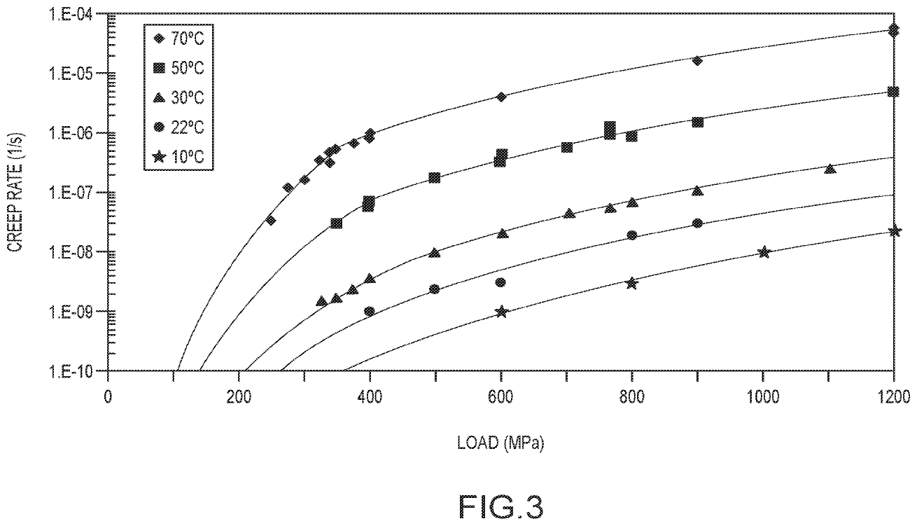

FIG. 2 and FIG. 3 show creep rates of exemplary first fibers, DYNEEMA® SK75 and DYNEEMA® SK78, and are from “Predicting the Creep Lifetime of HMPE Mooring Rope Applications” by Vlasbom and Bosman, referenced above. More specifically, FIG. 2 shows creep rate for DYNEEMA® SK75 at different temperatures and while subjected to different loadings. FIG. 3 shows creep rate for DYNEEMA® SK78 at different temperatures and while subjected to different loadings.

Table 1 below provides calculations for creep rate of DYNEEMA® SK75 and DYNEEMA® SK78 based on FIG. 2 and FIG. 3.

TABLE 1
Creep rate for DYNEEMA ® SK75 and DYNEEMA ® SK78 at 20°
C. while subjected to a stress of varying stresses.

| | | |
|---|---|---|
| | Stress | Creep Rate |
| Temperature (° C.) | (gram/dtex) | (1/sec) |

DYNEEMA ® SK75 Creep Rate

| | | |
|---|---|---|
| 20 | 4.203579348 | 4.00 × 10⁻⁹ |
| 20 | 6.305369022 | 2.00 × 10⁻⁸ |
| 20 | 8.407158696 | 3.00 × 10⁻⁸ |
| 20 | 10.50894837 | 8.00 × 10⁻⁸ |
| 20 | 12.61073804 | 3.00 × 10⁻⁷ |

DYNEEMA ® SK78 Creep Rate

| | | |
|---|---|---|
| 20 | 4.203579348 | 1.00 × 10⁻⁹ |
| 20 | 6.305369022 | 4.00 × 10⁻⁹ |
| 20 | 8.407158696 | 2.00 × 10⁻⁸ |
| 20 | 10.50894837 | 3.00 × 10⁻⁸ |
| 20 | 12.61073804 | 9.00 × 10⁻⁸ |

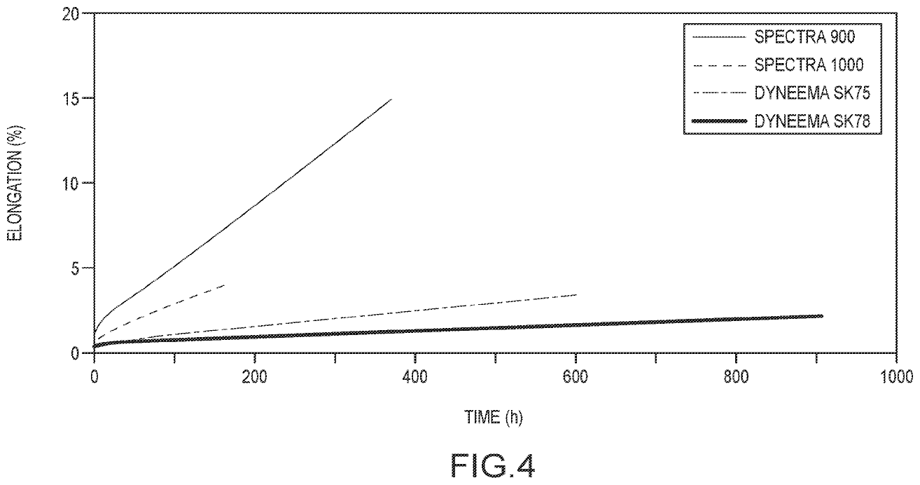

FIG. 4 shows percent elongation over time for four different fibers at 30° C. and a 400 MPa load: Spectra 900, Spectra 1000, DYNEEMA® SK75 and DYNEEMA® SK78. FIG. 4 is from “Predicting the Creep Lifetime of HMPE Mooring Rope Applications” by Vlasbom and Bosman, referenced above. Using data in FIG. 4, it appears that the creep rate of Spectra 1000 at 30° C. and 4.2 grams/dtex is 7×10⁻⁶. Based on FIG. 4 it appears that the creep rate of DYNEEMA® SK75 and DYNEEMA® SK78 at 30° C. and 4.2 grams/dtex is 2.1×10⁻⁶ and 6.2×10⁻⁷.

The creep rate profiles of Spectra 900 and Spectra 1000 are too high for use as first fibers in the instant disclosure. That is, Spectra 900 and Spectra 1000 do not qualify as first fibers of the instant disclosure because the creep rate of the fibers is too high.

Exemplary second fibers can be selected for various physical properties. For instance, second fibers can be selected for thermal stability, the relative coefficient of static friction, and modulus, to name a few examples.

In various implementations, the second fibers may comprise one or more of: lyotropic polymer filaments, thermotropic polymer filaments, and polyphenylene benzobisoxazole fibers. These types of fibers may include liquid crystal polymer fibers and aramid fibers. Commercially available examples of second fibers include KEVLAR® from Dupont (Wilmington, Del.), VECTRAN® from Kuraray Co. (Tokyo, Japan), and TECHNORA® from Teijin Ltd. (Osaka, Japan).

In some implementations, the second fibers can have a tensile strength of about 2720 MPa to about 3680 MPa; about 2720 MPa to about 3000 MPa; about 3000 MPa to about 3400 MPa; about 3400 MPa to about 3680 MPa; or about 3100 MPa to about 3300 MPa.

In some implementations, the second fibers can have an elongation at break of 3.3% to 3.7%; 3.3% to 3.5%; 3.5% to 3.7%; or 3.4% to 3.6%.

In some implementations, the second fibers can have a tensile modulus of about 64 GPa to about 86 GPa; about 64 GPa to about 76 GPa; about 75 GPa to about 86 GPA; about 70 GPa to about 80 GPa; or about 73 GPa to about 77 GPa. In some implementations, the second fibers can have a tenacity of 2.03 N/tex to 2.38 N/tex; 2.03 N/tex to 2.2 N/tex; 2.2 N/tex to 2.38 N/tex; 2.05 N/tex to 2.1 N/tex; 2.1 N/tex to 2.2 N/tex; 2.2 N/tex to 2.3 N/tex; or 2.28 N/tex to 2.38 N/tex.

A commercially available example second fiber having one or more of the aforementioned characteristics is VECTRAN® HT from Kuraray Co. (Tokyo, Japan). Without being bound by a particular theory, it appears that using VECTRAN® HT as the second fiber improves rope life over VECTRAN® UM as the second fiber.

Relative to each other, example second fibers have a lower creep rate profile than example first fibers. In example applications while subjected to load, as first fibers show creep relaxation behavior, the load can be shifted onto second fibers. By using low creep rate HMPE, exemplary ropes can delay the point at which load begins to shift onto the second fibers, thereby extending the life of the rope.

### IV. Exemplary Methods of Manufacture

Ropes disclosed and contemplated herein can be manufactured according to known techniques.

An example method of making a braided rope may include forming a plurality of rope strands and braiding the plurality of rope strands together to form the braided rope. Forming the plurality of rope strands can include blending together first fibers and second fibers using an “eye board” or a “holly board.”

As mentioned above, different numbers of rope strands may be braided together as desired, such as from 6 strands to 14 strands; 8 strands to 12 strands; 10 strands to 14 strands; 6 strands to 10 strands; or 8 strands to 10 strands. After braiding the rope strands together, the rope may be impregnated with a coating. The coating may act as a water sealant and/or lubricant. In some instances, the coating is polyurethane. In some instances, each of the twisted yarns does not include a lubricant between the first fibers and second fibers.

### V. Experimental Testing

Exemplary embodiments of ropes were manufactured and tested. For comparison, these exemplary ropes were compared against ropes falling outside of the scope of the ropes disclosed and contemplated herein.

A. CBOS Testing

More specifically, ropes including low-creep HMPE as first fibers and liquid crystal polymer as second fibers (VECTRAN® from Celanese Advanced Materials, Inc. (Charlotte, N.C.)) were compared to: (i) ropes with HMPE fibers that are not low-creep as first fibers and LCP as second fibers. The low-creep HMPE fibers were Jonnyma JF-33 and Winyarn Teximus AR. The test parameters for the ropes are provided in Table 2, below.

TABLE 2
CBOS test parameters for data in Table 3.

| | |
|---|---|
| Nominal Rope Diameter (mm) | 18 |
| Sheave Diameter (mm) | 457 |
| D:d ratio | 24:1* |
| Leg Load (Te) | 3.4 |
| Rope MBL (Te) | 31 |
| Life Factor | 218** |
| Safety Factor | 9.1:1 |
| Cycle Rate (cycles/min) | 18 |
| Groove Type | U-groove |
| Fleet Angle | 0 |
| Water Cooling | None |

*Based on imperial rope size of ¾″.
**Calculated as the product of the D:d ratio and the FOS

The results are provided in Table 3, below.

TABLE 3
Cyclic bend over sheave (CBOS) testing for various rope compositions,
where the second fiber type was a liquid crystal polymer.

| | | | | Average |
|---|---|---|---|---|
| | | | | number of |
| Rope size | First Fiber | | MBL leg | cycles to |
| (mm) | Type | Coating | tension (%) | failure |
| 18 | Spectra | Silicone- | 10 | 62,903 |
| | S1000 | based, | | |
| | | slippery | | |
| 18 | Spectra | Polyurethane | 10 | 182,102 |
| | S1000 | (Lago45) | | |
| 18 | Jonnyma JF- | Polyurethane | 10 | 296,190 |
| | 33 | (Lago45) | | |

As shown in Table 3, the rope with low-creep HMPE outperformed the ropes with Spectra S1000 fiber as the first fiber.

Two 9 mm (nominal diameter) ropes were also subjected to CBOS testing. Each rope had a D:d ratio of 19.2:1 and were subjected to MBL leg tension of 33%. One rope had Spectra S1000 as the first fiber and Vectran as the second fiber and the other rope had Winyarn Teximus AR as the first fiber and Vectran as the second fiber. The results are provided in Table 4, below.

TABLE 4
Cyclic bend over sheave (CBOS) testing for various rope compositions,
where the second fiber type was a liquid crystal polymer.

| | | | | Average |
|---|---|---|---|---|
| | | | | number of |
| Rope size | First Fiber | | MBL leg | cycles to |
| (mm) | Type | Coating | tension (%) | failure |
| 9 | Spectra | Polyurethane | 33 | 2,257 |
| | S1000 | (Lago45) | | |
| 9 | Winyam | Polyurethane | 33 | 3,896 |
| | Teximus AR | (Lago45) | | |

Based on the data in Table 3 and Table 4, ropes with the low-creep HMPE fibers as first fibers outperform the ropes with non-low-creep HMPE fibers. Winyarn has a published creep rate at 25° C. and 6.25 g/detx of 2.62×10⁻⁶ percent per second. Also, according to Winyarn, DYNEEMA® SK75 has a creep rate at 25° C. and 6.25 g/detx of 1.97×10⁻⁶ percent per second. Thus, it is hypothesized that a rope having DYNEEMA® SK75 as the first fiber would have similar lifetime performance improvement over Spectra S1000 as the Winyarn fiber because the DYNEEMA® SK75 has a lower creep rate than the Winyarn fiber. Further, based on FIG. 4, because DYNEEMA® SK78 has a lower creep rate than DYNEEMA® SK75, it is also hypothesized that a rope having DYNEEMA® SK78 as the first fiber would have similar lifetime performance improvement over Spectra S1000 as the Winyarn fiber because the DYNEEMA® SK78 has a lower creep rate than the Winyarn fiber.

B. Tension Fatigue and Creep Rate Correlation Testing

Tension fatigue cycle failure on HMPE fiber ropes may be considered to be plastic deformation and/or creep driven. In particular, tension fatigue testing may be correlated to creep elongation and creep failure. Tension fatigue tests were performed on 1 inch diameter HMPE ropes made with identical construction and coating to compare the relative creep performance of different HMPE fibers. The fibers were ranked according to their performance in order to evaluate the best candidates for a rope, as it was speculated that increasing the creep resistance of the HMPE component in the rope would also increase the rope's bending fatigue resistance.

The tests utilized a 600 Te capacity Chant tensile test machine which at the time was located in Sugar Land, Texas, to cycle the 1″ diameter ropes. The Thousand Cycle Load Limit (TCLL) procedure mentioned in “Guidelines for the Purchasing and Testing of SPM Hawsers,” OCIMF, First Edition, 2000, was followed. Testing was conducted in both dry and wet conditions. Table 5, below, shows the loading routine programmed into the test bed.

TABLE 5
Loading routine that was programmed into the testbed.

| | Upper | | Lower | | | |
|---|---|---|---|---|---|---|
| | Cycling | Upper | Cycling | Lower | | Number |
| | Load | Dwell | Load | Dwell | Load Rate | of |
| Step | (kips) | Time | (kips) | Time | (kips/second) | Cycles |
| 1 | 62.5 | 0 | 10 | 0 | 5.25 | 1000 |
| 2 | 75 | 0 | 10 | 0 | 6.5 | 1000 |
| 3 | 87.5 | 0 | 10 | 0 | 7.75 | 1000 |
| 4 | 100 | 0 | 10 | 0 | 9 | 2000 |

Samples that survived the 5000 cycles were allowed to rest overnight and then pulled to destruction. Test results are shown in FIG. 5. The Jonnyma JF33 was not tested in wet conditions.

Based on these results, the tested fibers can be ranked in terms of creep performance from best to worst as in Table 6.

TABLE 6
Creep performance ranking based on tension fatigue testing.

| Creep | |
|---|---|
| Performance | |
| Ranking | Fiber |
| 1 | Dyneema SK78 |
| 2 | Jonnyma JF33 |
| 3 | Spectra HC |
| 4 | Winyam AR |
| 5 | Spectra 1000 |

The foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure. One or more independent features and/or independent advantages of the disclosed technology may be set forth in the claims.

What is claimed is:

1. A braided rope comprising:
a plurality of braided strands comprising twisted yarns, each of the twisted yarns comprising a blend of first fibers and second fibers, the first fibers being high modulus polyethylene (HMPE) fibers, the second fibers being lyotropic polymer filaments, thermotropic polymer filaments, or polyphenylene benzobisoxazole fibers,
wherein the first fibers have a creep rate of no more than 3.0×10⁻⁸ percent per second at 20° C. while subjected to a stress of 5.0 grams/dtex.

2. The braided rope according to claim 1, wherein the first fibers have a creep rate of no more than 1.0×10⁻⁷ percent per second at 20° C. while subjected to a stress of 7.5 grams/dtex; and
wherein the second fibers are liquid crystal polymer (LCP) fibers or aramid fibers.

3. The braided rope according to claim 2, wherein the braided rope is a braided 12 strand rope.

4. The braided rope according to claim 2, wherein the braided rope is a braided 12×12 strand rope.

5. The braided rope according to claim 2, wherein a nominal diameter of the braided rope is at least 50 millimeters (mm).

6. The braided rope according to claim 1, wherein the second fibers have a tensile strength of about 3200 MPa, an elongation at break of 3.3% to 3.7%, a tensile modulus of about 75.0 GPa, and a tenacity of 2.03 N/tex to 2.38 N/tex.

7. The braided rope according to claim 1, wherein each of the twisted yarns has a ratio of first fibers to second fibers of from 45:55 to 55:45 by volume.

8. The braided rope according to claim 7, wherein the ratio of first fibers to second fibers is from 38:62 to 46:54 by weight.

9. The braided rope according to claim 1, wherein each of the twisted yarns does not include a lubricant between the first fibers and second fibers.

10. The braided rope according to claim 9, wherein the first fibers and the second fibers are evenly blended within each of the twisted yarns.

11. The braided rope according to claim 1, wherein the second fibers include a spin finish on an exterior of the second fibers.

12. The braided rope according to claim 1, further comprising a coating on at least a portion of an exterior of the braided rope, the coating being an anionic polyurethane.

13. The braided rope according to claim 1, wherein the first fibers have a creep rate of no more than 2.0×10⁻⁷ percent per second at 20° C. while subjected to a stress of 8.75 grams/dtex.

14. The braided rope according to claim 1, wherein the first fibers have a creep rate of no more than 1.0×10⁻⁶ percent per second at 20° C. while subjected to a stress of 12.25 grams/dtex.

15. The braided rope according to claim 1, wherein the first fibers have a creep rate of no more than 2.0×10⁻⁶ percent per second at 20° C. while subjected to a stress of 15 grams/dtex.

16. A method of making a braided rope, the method comprising:
forming a plurality of rope strands, comprising:
blending together first fibers and second fibers, the first fibers being high modulus polyethylene (HMPE) fibers, the second fibers being lyotropic polymer filaments, thermotropic polymer filaments, or polyphenylene benzobisoxazole fibers,
wherein the first fibers have creep rate of no more than 3.0×10⁻⁸ percent per second at 20° C. while subjected to a stress of 5.0 grams/dtex; and
wherein the first fibers have a creep rate of no more than 1.0×10⁻⁷ percent per second at 20° C. while subjected to a stress of 7.5 grams/dtex; and
braiding the plurality of rope strands together to form the braided rope.

17. The method according to claim 16, wherein the second fibers have a tensile strength of about 3200 MPa, an elongation at break of 3.3% to 3.7%, a tensile modulus of about 75.0 GPa, and a tenacity of 2.03 N/tex to 2.38 N/tex.

18. The method according to claim 17, further comprising:
adding a coating on at least a portion of an exterior of the braided rope, the coating being an anionic polyurethane,
wherein the second fibers include a spin finish on an exterior of the second fibers; and
wherein the ratio of first fibers to second fibers is from 38:62 to 46:54 by weight.

19. A braided rope comprising:
a plurality of braided strands comprising twisted yarns, each of the twisted yarns comprising a blend of first fibers and second fibers, the first fibers being high modulus polyethylene (HMPE) fibers, the second fibers being lyotropic polymer filaments, thermotropic polymer filaments, or polyphenylene benzobisoxazole fibers,
wherein the first fibers have creep rate of no more than 3.0×10⁻⁸ percent per second at 20° C. while subjected to a stress of 5.0 grams/dtex;
wherein the first fibers have a creep rate of no more than 1.0×10⁻⁷ percent per second at 20° C. while subjected to a stress of 7.5 grams/dtex;
wherein the second fibers have a tensile strength of about 3200 MPa, an elongation at break of 3.3% to 3.7%, a tensile modulus of about 75.0 GPa, and a tenacity of 2.03 N/tex to 2.38 N/tex;
wherein each of the twisted yarns has a ratio of first fibers to second fibers of from 45:55 to 55:45 by volume; and
wherein the ratio of first fibers to second fibers is from 38:62 to 46:54 by weight.

20. The braided rope according to claim 19, further comprising a coating on at least a portion of an exterior of the braided rope, the coating being an anionic polyurethane,
wherein each of the twisted yarns does not include a lubricant between the first fibers and second fibers;
wherein the first fibers and the second fibers are evenly blended within each of the twisted yarn; and
wherein the second fibers include a spin finish on an exterior of the second fibers.
